(19) United States
(12) Patent Application Publication
(10) Pub. No.: US 2015/0376063 A1
(43) Pub. Date: Dec. 31, 2015

(54) Ultra-Lightweight Gypsum Wallboard

(71) Applicant: Boral IP Holdings (Australia) Pty Limited, Sydney (AU)

(72) Inventor: Hubert C. Francis, Lithonia, GA (US)

(21) Appl. No.: 14/317,647

(22) Filed: Jun. 27, 2014

(51) Int. Cl. C04B 28/14; B32B 18/00; B32B 29/00; E04B 2/72

(52) U.S. Cl. CPC C04B 28/147; E04B 2/723; B32B 18/00; B32B 29/005; E04B 2103/02; B32B 2255/12; B32B 2255/20; B32B 2607/02

(57) ABSTRACT

A gypsum wallboard and a method of making the wallboard using a modified beta-gypsum hemihydrate obtained by calcining gypsum in the presence of a calcination modifier, under conditions for forming a beta-gypsum hemihydrate, wherein the wallboard is prepared using a stucco slurry formed by mixing the modified beta-gypsum hemihydrate with water, pre-gelatinized starch and a stucco dispersant.

### BACKGROUND

Gypsum is a popular component of industrial and building materials. Gypsum wallboard is widely used in building constructions and is used primarily as interior walls and ceilings. To ease wallboard installation, there has been a concerted effort to reduce gypsum wallboard weight, while retaining board strength and flexural properties. Manufacturing lightweight gypsum wallboards usually requires the use of high strength stucco and a pre-gelatinized starch to achieve desirable physical wallboard properties, including nail pull resistance. Starches (e.g., pre-gelatinized starches) are added to gypsum-containing materials in order to increase the compressive and flexural strength of the gypsum-containing wallboard core.

A main impediment to successfully manufacturing lightweight gypsum wallboard, however, has been managing the increased water demand caused by the use of pre-gelatinized starch. Pre-gelatinized starches significantly increase the water demand associated with the preparation of the stucco slurry used in fabricating the wallboard. As understood by those skilled in the art, the water demand of a stucco slurry formulation (also sometimes referred to as the “consistency” of the stucco) is the volume (or mass) of water necessary for yielding a stucco slurry of the required flow characteristic (fluidity) demanded by the high speed, commercial manufacturing process. Any water added beyond the amount required to re-hydrate the stucco must be removed from the slurry as the board is manufactured. The need to remove this excess water increases energy costs. In addition, board strength is known to be inversely proportional to the amount of water used in manufacturing the wallboard. As a result, an increased water demand due to the presence of a pre-gelatinized starch also tends to contribute to substandard wallboard strengths.

As used throughout the specification and claims, the phrase “ultra-lightweight gypsum wallboard” and the like refers to a board product having a set gypsum core formed between two substantially parallel cover sheets, wherein the set gypsum core has a weight (adjusted to a ½ inch thick board product) of between about 500 and about 1300 pounds per thousand square feet of board, i.e., a density of between approximately 12 and 32 pounds per cubic foot.

The prior art has attempted with limited success to manufacture ultra-lightweight gypsum wallboard. In one recent approach, a stucco slurry is prepared with a pre-gelatinized starch, a naphthalene-sulfonate dispersant and preferably a trimetaphosphate salt (e.g., STMP), see U.S. Pat. No. 7,731,794. The combination of the naphthalene-sulfonate dispersant and the trimetaphosphate salt is alleged to so-increase the fluidity of the stucco slurry that it is possible to reduce the water demand even in the presence of high amounts of pre-gelatinized starch.

Other ways of reducing the water demand of a stucco slurry have also been suggested. For example, calcium chloride has been used in the calcination of gypsum in order to reduce stucco water demand. However, deliquescence of residual calcium chloride renders the calcined gypsum-containing materials unacceptable for use in gypsum wallboard manufacture. Under humid conditions, deliquescence of residual calcium chloride contributes to bond failure between the gypsum core and the cover sheets.

### SUMMARY

This Summary is provided to introduce a selection of concepts in a simplified form that are further described below in the Detailed Description. This Summary is not intended to identify key or essential features of the invention.

Low consistency, high-strength gypsum hemihydrate (stucco) and high-strength, ultra-lightweight gypsum wallboard, as well as methods of manufacturing such gypsum hemihydrate and gypsum wallboard, are disclosed herein.

In various embodiments, a method is provided wherein gypsum is calcined to form a crystalline beta-gypsum hemihydrate in the presence of a calcination modifier, and the crystalline beta-gypsum hemihydrate (hereinafter also referred to as beta modified stucco) is mixed with starch, especially a pre-gelatinized starch to form a stucco slurry for making a wallboard product.

Additional embodiments are described herein.

### DETAILED DESCRIPTION

Low consistency, high-strength stucco, also known as gypsum hemihydrate or calcined gypsum, and high-strength, ultra-lightweight gypsum wallboard, as well as methods of manufacturing such gypsum hemihydrate and gypsum wallboard, are disclosed herein.

Various embodiments are directed to a method comprising, consisting essentially of, or consisting of calcining gypsum in the presence of a calcination modifier, thereby forming a modified stucco (modified beta (β)-gypsum hemihydrate) of a lowered water demand; and mixing the modified stucco (modified β-gypsum hemihydrate) with a pre-gelatinized starch and a gypsum dispersant, thereby forming a modified stucco-containing slurry.

The modified stucco-containing slurry is then deposited onto a cover sheet and more often between substantially parallel cover sheets and following conventional steps of setting, cutting and drying, a gypsum wallboard product is obtained.

As used herein, “gypsum” refers to the dihydrate of calcium sulfate (CaSO₄.2H₂O). In practicing the present invention, the source of gypsum is not particularly limited. For instance, the gypsum may be natural gypsum, or a synthetic gypsum (e.g., a by-product gypsum, recycled gypsum, neutralized gypsum, etc.). Examples of the gypsum usable herein thus include, but are not limited to, natural gypsum, titanogypsum, phosphogypsum, fluorogypsum, desulfogypsum (i.e., waste gypsum from flue gas desulfurization processes), recycled gypsum (e.g., obtained from waste gypsum boards), and combinations thereof. A natural source of gypsum is a particularly suitable raw material for the present invention.

As known to those skilled in the wallboard art, to produce the stucco needed to make the wallboard product, the gypsum is dried, appropriately sized (possibly with grinding) and then calcined, usually at a temperature of about 125° C. or higher in a suitable kiln to yield the stucco, also known as gypsum hemihydrate or calcined gypsum.

There are two types of calcined gypsum, alpha-calcium sulfate hemihydrate (alpha-gypsum hemihydrate) and beta-calcium sulfate hemihydrate (beta-gypsum hemihydrate), which are produced by significantly different calcinations methods. Alpha-gypsum hemihydrate (or alpha gypsum) is prepared by calcining gypsum under pressure, usually in the presence of pressurized steam. Beta-gypsum hemihydrate (or beta gypsum) is made by calcining the gypsum in a kettle or kiln, usually in a continuous manner, at substantially atmospheric pressure.

The stucco used for making gypsum wallboard is almost exclusively in the beta-hemihydrate form. Thus, for wallboard stucco, the calcination is conducted at essentially atmospheric pressure conditions, and generally is done continuously, such as in a rotary calciner or a fluidized bed calciner. Again, under these conditions a form of stucco identified as beta (β) calcium sulfate (gypsum) hemihydrate is formed. The resulting stucco typically exhibits a water demand or consistency of more than about 70 to 80 ml of water per 100 grams of stucco solids. The other form of calcined gypsum, made by calcining at an elevated pressure, usually in the presence of pressurized steam and identified as alpha (α) gypsum hemihydrate, is not used commercially in the production of gypsum wallboard. Alpha gypsum hemihydrate is not used primarily due to its slower hydration rate compared to beta-gypsum hemihydrate (which would accordingly require significantly slower line speeds), and the lower strength characteristics of the resulting wallboard product obtained when alpha-gypsum hemihydrate is used at core densities common to wallboard manufacturing. Nonetheless, alpha-gypsum hemihydrate typically exhibits a much lower water demand or consistency, usually less than 50 ml, and often on the order of between about 30 to 45 ml of water per 100 grams of stucco. Unfortunately, as noted above, alpha-gypsum hemihydrate does not set sufficient fast to be used for making wallboard under the high speeds required by commercial manufacturing facilities.

As a result, the present invention is limited to the use of stucco (gypsum hemihydrate) made under substantially atmospheric conditions, i.e., the invention is directed to the use of beta calcium sulfate hemihydrate (beta-gypsum hemihydrate). In fact, it is preferred that the stucco used in accordance with the present invention is substantially free of any alpha-gypsum hemihydrate. In accordance with the present invention, however, the beta-gypsum hemihydrate is a modified form of the hemihydrate, as disclosed hereafter, such that it exhibits a water demand or consistency making it suitable for use in making an ultra-lightweight gypsum wallboard.

To convert the so-produced stucco back into gypsum (also referred to herein as set gypsum), the stucco is mixed with sufficient water, and other additives. In accordance with the present invention, the stucco is mixed with a dispersant (also known as a water reducer), pre-gelatinized starch and optionally a foaming agent, usually supplied as a pre-generated foam. Importantly, there is no need to use any trimetaphosphate salt(s), such as STMP, in producing the ultra-lightweight wallboard of the present invention. As a result, it also is preferred that the stucco slurry used in accordance with the present invention is substantially free of any trimetaphosphate salt(s), such as STMP.

By virtue of the manner in which the gypsum is calcined in accordance with the present invention, the water demand of the resulting stucco (beta-gypsum hemihydrate) is reduced. In particular, in accordance with the present invention, the gypsum is calcined at substantially atmospheric pressure, usually in a continuous manner, in the presence of a calcination modifier to produce a modified beta-gypsum hemihydrate. To produce a stucco slurry using the modified beta-gypsum hemihydrate typically requires about 50 to 85% by weight water based on the weight of the modified beta-gypsum hemihydrate.

As used herein, the term “calcination modifier” refers to a compound, which when present with gypsum in the calciner, modifies the manner by which the beta calcium sulfate hemihydrate (beta-gypsum hemihydrate) forms during calcination of the gypsum under substantially atmospheric pressure conditions. In various embodiments, the calcination modifier influences and/or controls the nature of the gypsum hemihydrate crystal formed during the calcination of gypsum. Not wishing to be bound by any theory, it is believed that the calcination modifier controls the development of the gypsum hemihydrate crystals to produce crystals with a specific shape and/or aspect ratio that leads to a calcined beta-gypsum product having a lower water demand or lower consistency then one would a usually encounter with a beta calcium sulfate hemihydrate.

In certain embodiments, the calcination modifier may be a carboxylic acid, carboxylic acid anhydride, carboxylic acid salt, or a combination thereof. As used herein, “carboxylic acid” encompasses, saturated and unsaturated, monocarboxylic acids, dicarboxylic acids, tricarboxylic acids, polycarboxylic acids, and combinations thereof. Representative examples of calcination modifiers encompassed by the various embodiments include, but are not limited to, acetic acid, acetic anhydride, an acetic acid salt, adipic acid, adipic acid anhydride, an adipic acid salt, aspartic acid, aspartic anhydride, an aspartic acid salt, citric acid, citric acid anhydride, a citric acid salt, formic acid, formic acid anhydride, a formic acid salt, fumaric acid, a fumaric acid salt, gluconic acid, gluconic acid anhydride, a gluconic acid salt, maleic acid, maleic anhydride, a maleic acid salt, malic acid, malic anhydride, a malic acid salt, malonic acid, malonic acid anhydride, a malonic acid salt, oxalic acid, oxalic acid anhydride, a oxalic acid salt, succinic acid, succinic anhydride, a succinic acid salt, sulfosuccinic acid, sulfosuccinic anhydride, a sulfosuccinic acid salt, tartaric acid, tartaric anhydride, a tartaric acid salt, and combinations thereof. Exemplary carboxylic acid salts include, but are not limited to, sodium acetate, potassium acetate, calcium acetate, sodium adipate, potassium adipate, calcium adipate, sodium aspartate, potassium aspartate, calcium aspartate, sodium citrate, potassium citrate, calcium citrate, sodium formate, potassium formate, calcium formate, sodium fumarate, potassium fumarate, calcium fumarate, sodium gluconate, potassium gluconate, calcium gluconate, sodium maleate, potassium maleate, calcium maleate, sodium malate, potassium malate, calcium malate, sodium malonate, potassium malonate, calcium malonate, sodium oxalate, potassium oxalate, calcium oxalate, sodium succinate, potassium succinate, calcium succinate, sodium sulfosuccinate, potassium sulfosuccinate, calcium sulfosuccinate, sodium tartrate, potassium tartrate, calcium tartrate, and combinations thereof. In various embodiments, no calcium chloride is present during calcination, i.e., the calcination is conducted in the absence of any added calcium chloride.

A suitable calcination modifier can usually be selected from one or more of maleic acid, tartaric acid, succinic acid, sodium succinate polyacrylic acid, lactic acid, aspartic acid, citric acid, sodium citrate, monosodium gluconate, tartaric acid tri-polyphosphate, monosodium gluconate, ethylene diamine tetra-acetic acid or its sodium salt, and the penta-sodium salt of amino trimethylene phosphonic acid.

In accordance with the present invention, any manner by which the calcination modifier and gypsum can be brought together in the calciner can be used for making the modified beta-gypsum hemihydrate. For example, the gypsum and calcination modifier may be mixed/stirred together or ground together before introduction into the calciner, the gypsum may be soaked in a solution of calcination modifier, the gypsum may be sprayed with a solution of the calcination modifier, the gypsum may be coated by any suitable technique with the calcination modifier, the gypsum may be immersed in a solution of the calcination modifier. Any piece of suitable equipment for accomplishing any of these compounding methods can be used (e.g., a mixer, a spray nozzle, a hopper, etc.). The manner of compounding the calcination modifier with the gypsum for exposure together in the calciner is not narrowly critical. The selection of a suitable technique and suitable conditions for compounding any particular source of the gypsum and a calcination modifier (e.g., mixing technique, gypsum/calcination modifier contact time, mixing speed, gypsum to calcination inhibitor ratio, etc.) will be well within the bounds of routine testing for those skilled in the art.

At least one calcination modifier is used during calcination of the gypsum. For example, in certain embodiments, only one calcination modifier, selected from the group consisting of acetic acid, acetic anhydride, an acetic acid salt, adipic acid, adipic acid anhydride, an adipic acid salt, aspartic acid, aspartic anhydride, an aspartic acid salt, citric acid, citric acid anhydride, a citric acid salt, formic acid, formic acid anhydride, a formic acid salt, fumaric acid, a fumaric acid salt, gluconic acid, gluconic acid anhydride, a gluconic acid salt, maleic acid, maleic anhydride, a maleic acid salt, malic acid, malic anhydride, a malic acid salt, malonic acid, malonic acid anhydride, a malonic acid salt, oxalic acid, oxalic acid anhydride, a oxalic acid salt, succinic acid, succinic anhydride, a succinic acid salt, sulfosuccinic acid, sulfosuccinic anhydride, a sulfosuccinic acid salt, tartaric acid, tartaric anhydride, and a tartaric acid salt, is used for calcining. In other embodiments, combinations of two or more calcination inhibitors are used, including combinations of any two or more, three or more, four or more, five or more, etc. of the calcination inhibitors described herein. For instance, in certain embodiments, the calcination inhibitor is a combination of acetic acid and acetic anhydride, a combination of acetic acid and an acetic acid salt, a combination of acetic anhydride and an acetic acid salt, a combination of succinic acid and succinic anhydride, a combination of succinic acid and a succinic acid salt, a combination of succinic anhydride and a succinic acid salt, a combination of acetic acid and succinic acid, a combination of acetic anhydride and succinic anhydride, a combination of an acetic acid salt and a succinic acid salt, etc. In other embodiments, the calcination inhibitor is a combination of acetic acid, acetic anhydride and an acetic acid salt, a combination of succinic acid, succinic anhydride and succinic acid salt, etc.

The calcination modifier should be present in the calciner in an amount from about 0.01 to about 10.0 weight percent (wt. %) based on the weight of gypsum (i.e., from about 0.01 to about 10 parts of calcination modifier for each 100 parts of gypsum). Usually, an amount of calcination modifier in the range of about 0.05 to about 5 wt % based on the weight of gypsum should be sufficient. For most gypsum sources, an amount of calcination modifier in the range of about 0.05 to about 2 wt % should be satisfactory. In certain embodiments, the calcination inhibitor is present in an amount from about 0.05 to about 5 wt. % based on the weight of gypsum, from about 0.05 to about 2 wt. % based on the weight of gypsum, or from about 0.1 to about 1.0 wt. % based on the weight of gypsum.

Broadly, “calcining” refers to the high-temperature thermal treatment of a solid material to cause removal of a volatile fraction, thermal decomposition, phase transition, or a combination thereof. In the present invention, the calcination step removes bound water from gypsum (calcium sulfate dihydrate) to yield stucco (calcium sulfate hemihydrate). Calcination, according to various embodiments, is not limited to any particular apparatus or equipment. Any suitable furnace or reactor may be used. In certain embodiments, a kettle calciner, a rotary kiln, or a combination thereof may be used to carry out the calcination. What is important is that the calcination is done at substantially atmospheric pressure and is usually done in a continuous (as contrasted with a batch) process so that the beta-gypsum form of the hemihydrate would be produced.

In various embodiments, calcining may be carried out at any temperature suitable to convert gypsum to crystalline gypsum hemihydrate. In certain embodiments, calcining may be carried out at a temperature in the range of about 120° C. to about 260° C., the range of about 125° C. to about 240° C., the range of about 125° C. to about 220° C., the range of about 130° C. to about 200° C., the range of about 130° C. to about 190° C., the range of about 135° C. to about 180° C., the range of about 135° C. to about 170° C., the range of about 140° C. to about 170° C. In some embodiments, calcining may be carried out at a temperature of about 120° C., about 125° C., about 130° C., about 135° C., about 140° C., about 145° C., about 150° C., about 155° C., about 160° C., about 165° C., about 170° C., about 175° C., about 180° C., about 185° C., about 190° C., about 195° C., about 200° C., about 210° C., or about 240° C.

In numerous embodiments, calcining may be carried out for any suitable time period as required to reduce the content of bound water from the gypsum (calcium sulfate dihydrate) to on-average one-half of mole of water per mole of calcium sulfate, i.e., to calcium sulfate hemihydrate. The calcination should not be prolonged so as to promote the formation of insoluble anhydrous gypsum. In certain embodiments, calcining may be carried continuously, such that the average residence time of the gypsum in the calcinier is in the range of about 0.5 hour to 2 hours, usually between about 0.75 hour and 1.5 hours.

As compared to beta-gypsum hemihydrate produced via calcination of gypsum in the absence of a calcination modifier, the crystalline beta-gypsum hemihydrate produced in the presence of a calcination modifier in accordance with the present invention has a modified crystal shape that results in a modified beta-gypsum hemihydrate that has a lower water demand (lower consistency). In other words, as compared to gypsum beta-hemihydrate produced via calcination of gypsum in the absence of a calcination modifier, the crystalline gypsum beta-hemihydrate produced in the presence of a calcination modifier produces a stucco with a lower water demand. Without being bound by theory, it is believed that this reduction in water demand is due to the modified form of the beta-gypsum hemihydrate crystals formed in the presence of the calcination modifier.

Following calcination, the modified beta-gypsum hemihydrate can be subjected to conventional post-calcination operations for recovering the stucco, including possibly cooling, screening, etc.

In preparing the ultra-lightweight gypsum wallboard of the present invention, a stucco slurry is prepared from the modified beta-gypsum hemihydrate. The stucco is present in the slurry in an amount of at least about 50% by weight of the dry materials used to prepare the stucco slurry. Usually, the amount of stucco is at least 80% by weight of the dry materials used to make the slurry. Often in many wallboard formulations the dry component material is more than 90% or even 95% by weight stucco. The presence of some soluble calcium sulfate anhydrite in the stucco is also contemplated, although its presence is generally sought to be limited. The presence of insoluble anhydrate, as usual, is to be avoided if possible.

At least one pre-gelatinized starch also is mixed with the modified beta-gypsum hemihydrate in preparing the stucco slurry. Starch (CAS# 9005-25-8) is a polysaccharide carbohydrate comprising a large number of glucose monosaccharide units joined together by glycosidic bonds. Starch is predominantly present in plants and seeds such as amylose and amylopectin. Depending on the plant, starch generally contains 20 to 25 percent amylose and 75 to 80 percent amylopectin. Polysaccharide starches include maize or corn, waxy maize, potato, cassava, tapioca and wheat starch. Other starches include varieties of rice, waxy rice, pea, sago, oat, barley, rye, amaranth, sweet potato, and hybrid starches available from conventional plant breeding, e.g., hybrid high amylose starches having amylose content of 40% or more, such as high amylose corn starch. Also potentially useful are genetically engineered starches such as high amylose potato and waxy potato starches.

The starch is pre-gelatinized for use in making gypsum wallboard. Pre-gelatinized starch, which is also termed cold-swelling starch, has been chemically and/or mechanically processed to rupture all or part of the starch granules. In contrast to native starch, pre-gelatinized starch can be soluble in cold water, or can form dispersions, pastes, or gels with cold water, depending on the concentration of the pre-gelatinized starch used and on the type of starch used to produce the pre-gelatinized starch. In principle it is possible to produce pre-gelatinized starch by various processes, for example by wet-thermal digestion using a roller dryer, mechanical, and thermal treatment with an extruder, or exclusively mechanical treatment with a vibratory mill. In all processes the starch grain structure and the para-crystalline molecular organization is disrupted, and the starch is converted into an amorphous substance. In addition to pre-gelatinization, the starches can be further physically modified, e.g., by extrusion, spray drying, drum drying, and agglomeration.

The starch also can be chemically modified or derivatized, such as by etherification, esterification, acid hydrolysis, dextrinization, crosslinking, cationization, heat-treatment or enzyme treatment (e.g., with alpha-amylase, beta-amylase, pullulanase, isoamylase, or glucoamylase). One exemplary starch is a hydroxyalkylated starch such as a hydroxypropylated or hydroxyethylated starch, and succinated starches such as octenylsuccinated or dodecylsuccinated starches. Low amylose starches, i.e., starches containing less than 40% by weight amylose, also can be used. One commercially available starch is hydroxypropylated starch available from National Starch and Chemical Company. Other commercially available types of starches are waxy starches, also available from National Starch and Chemical Company. As used herein, the term “waxy” is intended to include a starch containing at least 95% by weight amylopectin.

Thus, in one embodiment the pre-gelatinized starch comprises a pre-gelatinized starch that has been chemically modified with a mono-reactive moiety to a degree of substitution of at least 0.015. In a particular embodiment, the pre-gelatinized starch is selected from the group consisting of ether and ester derivatives of starch, such as hydroxypropyl, hydroxyethyl, succinate, and octenyl succinate starch. In one specific embodiment the starch is a hydroxypropylated potato starch having a degree of substitution of 0.015-0.30 and a molecular weight of 200,000-2,000,000. Another specific embodiment comprises hydroxyethylated dent corn starch having a degree of substitution of 0.015-0.3 and a molecular weight of 200,000-2,000,000. Another specific embodiment comprises hydroxypropylated high-amylose corn starch with a degree of substitution of 0.015-0.3 and a molecular weight of 200,000-2,000,000.

Any suitable pre-gelatinized starch may be used to prepare the wallboard in accordance with the present invention. A variety of different types of pre-gelatinized starch are commercially available and can be used. An exemplary pre-gelatinized starch material is cold-water-soluble granular pre-gelatinized starch materials produced, for example, as described in U.S. Pat. No. 4,465,702 to Eastman et al. A pre-gelatinized corn starch of this type is available under the trade name MIRAGEL® 463, manufactured by the A. E. Staley Manufacturing Company, which thickens and sets to a gel using room temperature water. Other pre-gelatinized starches that can be used include UltraSperse® M, from National Starch and Chemical Company of Bridgewater, N.J.; pre-gelatinized waxy corn starch, available from National Starch and Chemical Company; and the hydroxyethylated dent corn starches available under the trade names ETHYLEX® 2005-2095, STARPOL and STARAMIC each commercially available from Tate & Lyle, UK, PCF 1000 Starch, commercially available from BUNGE North America and FLUIDEX and other starches, commercially available from Archer Daniels Midland Company.

The relative amount of the pre-gelatinized starch and the stucco will vary, depending on the desired properties of the gypsum board, the type of pre-gelatinized starch and the stucco used, and the presence and amounts of other optional additives, and can be readily determined by one of ordinary skill in the art without undue experimentation. For example, the stucco slurry broadly comprises from 0.5 to 10 weight percent (wt. %), usually from 2 to 10 weight percent (wt. %), and more often from 4 to 6 wt. %, of pre-gelatinized starch, based on the stucco dry weight in the slurry. In other words for every 100 parts by weight of dry stucco used to prepare the stucco slurry, there is between 0.5 and 10 parts by weight of pre-gelatinized starch. In certain embodiments, the pre-gelatinized starch may be present in an amount from about 2 to about 5 wt. % based on the weight of stucco, from about 4 to about 10 wt. % based on the weight of stucco, or from about 4 to about 8 wt. % based on the weight of stucco. In other embodiments, the pre-gelatinized starch may be present in an amount of about 2 wt. % based on the weight of stucco, about 3 wt. % based on the weight of stucco, about 4 wt. % based on the weight of stucco, about 5 wt. % based on the weight of stucco, about 6 wt. % based on the weight of stucco, about 7 wt. % based on the weight of stucco, about 8 wt. % based on the weight of stucco, about 9 wt. % based on the weight of stucco, or about 10 wt. % based on the weight of stucco.

In addition to the stucco and pre-gelatinized starch, the stucco slurry also includes a stucco dispersant, also known as a water reducing agent. In certain embodiments, the stucco dispersant, or water-reducing agent is added to the beta-gypsum hemihydrate-containing slurry in an amount that helps to reduce further the amount of excess water needed to produce a stucco slurry of the desired fluidity, i.e., an amount of dispersant suitable for reducing the water demand or consistency of the stucco formulation. Suitable water reducing agents or dispersants may include a lignosulfonate product (e.g, calcium lignosulfonate, and similar bi-products obtained from paper manufacturing, and the like), or an alkanol amine such as triethanolamine, diethanolamine, and the like. In other embodiments, the water reducing agent or dispersant can be a polynaphthalene sulfonate (e.g., polynaphthalene sulfonate-formaldehyde condensate salts, and the like), a polymelamine sulfonate (e.g., polymelamine sulfonate-formaldehyde salts, and the like), or a polycarboxylate. As recognized by those skilled in the gypsum wallboard art, suitable polycarboxylates are copolymers composed of various constituents, such as acrylic or methacrylic backbones with attached pendant chains based on ethylene oxide or propylene oxide. There is no criticality in the nature of the specific dispersant employed for reducing the water demand of the stucco. Those skilled in the art of gypsum wallboard manufacture are aware of the wide range of suitable stucco dispersants. According to various embodiments, a stucco dispersant or water-reducing agent is added to the gypsum hemihydrate-containing slurry in an amount of from about 0.25 to about 0.5 wt. % based on the weight of stucco.

The combination of a pre-gelatinized starch, dispersant and modified (crystalline) beta gypsum hemihydrate obtained via calcination with a calcination modifier in accordance with the present invention provides a reduction in water demand and according an increase in wallboard strength at equivalent amounts of unmodified stucco, starch and dispersant. Without being bound by theory, it is believed that this reduction in water demand and increase in stucco strength is due to the different crystal structure of the modified beta-gypsum hemihydrate.

In contrast to other light weight gypsum wallboards, the wallboards of the present invention are substantially free of any trimetaphosphate salt(s). Importantly, it is not necessary to use any trimetaphosphate salt(s) to obtain a suitable fluidity in the stucco slurry and to obtain suitable wallboard properties when making an ultra-lightweight wallboard in accordance with the present invention.

In operation, the dry stucco (modified beta-gypsum hemihydrate) is fed into a slurry mixer, commonly referred to as a “pin” mixer because of the usual design along with water. In some embodiments, the stucco is mixed with sufficient water such that the weight ratio of water to stucco (water:stucco) in the slurry is 0.5:1 to 0.9:1, usually 0.5:1 to 0.8:1 and often in the range of 0.6:1 to 0.8:1. Prior to entry into the mixer, other dry additives, such as the pre-gelatinized starch, or set accelerators, can be added to the powdered stucco. Still other additives are usually added directly to the mixer via a separate line. Some additives, such as the stucco dispersant, may also be added directly to the mixing water before the water is added into the mixer. This alternative is particularly convenient where the additives are in liquid form. For most additives, there is no criticality involved in the manner in which the additives are introduced into the stucco slurry, and they may be added using whatever equipment or method is convenient as understood by those skill in the wallboard manufacturing art.

In certain embodiments, mixing the modified beta-gypsum hemihydrate with pre-gelatinized starch further comprises mixing the modified gypsum hemihydrate with a foaming agent (an air entraining agent) or foam. Introducing foam into the stucco slurry allows for the production of a lighter weight final product (i.e. gypsum wallboard) by creating voids in the set gypsum. The nature of the foam is not particularly limited and those skilled in the wallboard manufacturing art are aware of a variety of foaming agents or soaps. In certain aspects, the foaming agent may comprise an anionic surfactant, a cationic surfactant, a nonionic surfactant, and the like. The foaming agent may include more than one surfactant. A suitable surfactant solution may comprise 30% to 60% of the active foaming agent. In certain embodiments, the foam is an aqueous foam. A variety of foams (soaps) are commercially available. Exemplary foaming agents (air-entraining agents) that are commercially available include, but are not limited to, the HYONIC® line of soaps from GEO Specialty Chemicals, Ambler, Pa., and CEDEPAL FA-406, an ammonium alkyl ether sulfate available from Stepan, Northfield, Ill. According to various embodiments, a foaming agent (an air-entraining agent) or soap is added to the stucco slurry in an amount from about 0.1 to about 0.4 wt. % based on the weight of stucco. For example, in a typical wallboard manufacturing facility, foam may be generated separately by combining the soap, a suitable dispersant and water. The foam can then be mixed with the previously mixed stucco slurry. For example, it can be injected into the moving stucco slurry after it exits from the mixer through a hose or chute. In some instances, the foaming agent may be in various forms, including a liquid, flake, and/or powdered form. The method of mixing foam with the stucco slurry is not an essential feature of the present invention. The soap foam introduces and distributes air (bubbles) voids in the set gypsum core, and contributes to a lowering of the density of the set gypsum core. A preferred range of soap in the set gypsum core is from about 0.2 pound per 1000 square feet of wallboard to about 0.7 pound per 1000 square feet of wallboard; a more preferred level of soap is about 0.3 pound per 1000 square feet of wallboard to about 0.5 pound per 1000 square feet of wallboard.

In further embodiments, still other ingredients may be used in minor amounts in the stucco slurry formulation. For example, glass fibers may be optionally added to the stucco slurry in amounts of up to 11 pounds per 1000 square feet of board (54 g/m²). Also, up to 15 pounds per 1000 square feet of board (73.2 g/m²) of paper fibers may be added to the stucco slurry. In some embodiments, a silicone oil may also be added to the stucco slurry, usually in small amounts, to improve the water-resistivity of the gypsum wallboard. In still other embodiments, other additives may also be added to the stucco slurry as are typical for any particular application. For example, a set retarder (up to about 2 pounds per 1000 square feet of board (9.8 g/m²)) or an accelerator (up to about 35 pounds per 1000 square feet of board (170 g/m²)) can be added to modify the rate at which the stucco hydration reactions take place. Exemplary accelerators include, but are not limited to, calcium sulfate, potassium sulfate, ball mill accelerator, and combinations thereof.

In making the wallboard, the stucco slurry is sandwiched between two substantially parallel cover sheets. Usually, the cover sheets are made of paper as in conventional gypsum wallboard, although other cover sheet materials known in the art (e.g. fibrous glass mats) also may be used. In some embodiments it may be preferred to use a particularly heavy paper cover sheet on one side of the board (usually the top face). Fibrous mats may also be used as one or both of the cover sheets. When used, the fibrous mats will usually be nonwoven glass fiber mats in which filaments of glass fiber are bonded together by an adhesive and often the nonwoven glass fiber mats will have a resin-based coating. Such cover sheets are well-known to those skilled in the gypsum wallboard art.

In various embodiments, a gypsum-based building material is formed from the gypsum-containing slurry. Exemplary gypsum-based building materials include, but are not limited to, ultra-lightweight gypsum wallboard, plasterboard, gypsum board, reinforced gypsum composite board, and combinations thereof. As used herein, an “ultra-lightweight” gypsum wallboard is a gypsum wallboard having a nominal thickness of ½ inch and a dry weight of 500 to 1300 pounds per 10000 square feet of board.

Gypsum wallboard must meet certain criteria which are set forth in ASTM Methods C-36 and C-473 and wallboard made in accordance with the teachings of the present invention satisfy these requirements. These ASTM methods are the tests, as defined by the American Society for Testing and Materials, West Conshohocken, Pa. for standardizing suitable wallboard properties. To the extent necessary for completion, these standardized test methods are expressly incorporated by reference. The C-36 test is the Standard Specification for Gypsum Wallboard while the C-473 test is the Standard Test Methods for Physical Testing of Gypsum Board Products and Gypsum Lath. Requirements for composition, flexural strength, humidified deflection, hardness, nail pull resistance, dimensions, and appearance are specified in these test procedures. One of the more critical requirements for gypsum board is the nail pull resistance. For a ½-inch board, an 80-Lb nail pull is specified. Again, wallboard made in accordance with the present invention can satisfy the criteria of ASTM C-36 and C-473.

While the disclosure has been described with respect to specific embodiments and variations, including presently preferred modes of carrying out the invention, those skilled in the art will appreciate that there are numerous variations, modifications and permutations of the above described systems and techniques that fall within the spirit and scope of the invention as set forth in the appended claims.

The various embodiments are not to be limited in scope by the specific embodiments disclosed in the examples. The specific embodiments disclosed in the examples are intended as illustrations of a few aspects, and any embodiments that are functionally equivalent are within the scope of this disclosure.

Although certain calcination modifiers and pre-gelatinized starches are used to illustrate certain variations, the various embodiments are suitable for the preparation of any ultra-lightweight gypsum wallboard disclosed herein, using any of the components disclosed herein. With the benefit of the present disclosure, one skilled in the art will recognize that various parameters may need to be adjusted to compensate for the use of a different component.

The terms used in the present specification shall be understood to have the meaning usually used in the field of art to which the various embodiments pertain, unless otherwise specified.

Where products are described herein as having, including, or comprising specific components, or where processes are described herein as having, including, or comprising specific process steps, it is contemplated that the products of the various embodiments can also consist essentially of, or consist of, the recited components, and that the processes of the various embodiments also consist essentially of, or consist of, the recited process steps.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, a numerical range of “1 to 5” should be interpreted to include not only the explicitly recited values of 1 and 5, but also individual values and sub-ranges within the indicated range. Thus, included in this numerical range are individual values such as 2, 3, 4, etc. and sub-ranges such as from 1 to 3, from 2 to 4, from 3-5, etc. The listing of exemplary values or ranges is not a disclaimer of other values or ranges between and including the upper and lower limits of a given range.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

It is noted that, as used herein and in the appended claims, the singular forms “a,” “an,” and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Each of the individual embodiments described and illustrated herein has discrete components and features which may be readily separated from or combined with the features of any of the other several embodiments without departing from the scope or spirit of the disclosure. Any recited method can be carried out in the order of events recited or in any other order which is logically possible. Thus, unless otherwise indicated or unless otherwise clear from the context in which it is described, alternative elements or features in the embodiments and examples above and in the Summary above are interchangeable with each other. That is, an element described in one example may be interchanged or substituted for one or more corresponding elements described in another example. Similarly, optional or non-essential features disclosed in connection with a particular embodiment or example should be understood to be disclosed for use in any other embodiment of the disclosed subject matter. More generally, the elements of the examples should be understood to be disclosed generally for use with other aspects and examples of the products and methods disclosed herein. A reference to a component or ingredient being operative, i.e., able to perform one or more functions, tasks and/or operations or the like, is intended to mean that it can perform the expressly recited function(s), task(s) and/or operation(s) in at least certain embodiments, and may well be operative to perform also one or more other functions, tasks and/or operations.

The various embodiments are not limited to particular embodiments described herein. Further, the terminology used herein is for the purpose of describing particular embodiments only, and is not intended to be limiting.

What is claimed:

1. An ultra-lightweight gypsum wallboard comprising a set gypsum core formed between two substantially parallel cover sheets, the set gypsum core formed by hydrating a modified beta-gypsum hemihydrate in a stucco slurry comprising the modified beta-gypsum hemihydrate, water, a pre-gelatinized starch and a stucco dispersant, wherein the modified beta-gypsum hemihydrate is prepared by calcining gypsum in the presence of a calcination modifier under conditions for producing beta-gypsum hemihydrate.

2. The gypsum wallboard of claim 1 wherein the calcination modifier is selected from the group consisting of saturated and unsaturated, monocarboxylic acids, dicarboxylic acids, tricarboxylic acids, polycarboxylic acids, and combinations thereof.

3. The gypsum wallboard of claim 2 wherein the calcination modifier is selected from the group consisting of acetic acid, acetic anhydride, an acetic acid salt, adipic acid, adipic acid anhydride, an adipic acid salt, aspartic acid, aspartic anhydride, an aspartic acid salt, citric acid, citric acid anhydride, a citric acid salt, formic acid, formic acid anhydride, a formic acid salt, fumaric acid, a fumaric acid salt, gluconic acid, gluconic acid anhydride, a gluconic acid salt, maleic acid, maleic anhydride, a maleic acid salt, malic acid, malic anhydride, a malic acid salt, malonic acid, malonic acid anhydride, a malonic acid salt, oxalic acid, oxalic acid anhydride, a oxalic acid salt, succinic acid, succinic anhydride, a succinic acid salt, sulfosuccinic acid, sulfosuccinic anhydride, a sulfosuccinic acid salt, tartaric acid, tartaric anhydride, a tartaric acid salt, and combinations thereof.

4. The gypsum wallboard of claim 1 wherein the calcination modifier is selected from the group consisting of maleic acid, tartaric acid, succinic acid, sodium succinate polyacrylic acid, lactic acid, aspartic acid, citric acid, sodium citrate, monosodium gluconate, tartaric acid tri-polyphosphate, monosodium gluconate, ethylene diamine tetra-acetic acid or its sodium salt, and the penta-sodium salt of amino trimethylene phosphonic acid.

5. The gypsum wallboard of claim 1 wherein the pre-gelatinized starch is present in the stucco slurry an amount of 0.5 to 10% by weight of the modified beta-gypsum hemihydrate.

6. The gypsum wallboard of claim 5 wherein the pre-gelatinized starch is selected from the group consisting of hydroxyethylated starch, pre-gelatinized corn starch, pre-gelatinized waxy corn starch, pre-gelatinized rice starch, pre-gelatinized wheat starch, hydroxypropylated starch, hydroxyethylated starch, succinated starch, acetylated starch, dextrinized starch, and combinations thereof.

7. The gypsum wallboard of claim 1 wherein the calcination modifier is present in an amount of from about 0.05 to about 10 weight percent (wt. %) based on the weight of gypsum.

8. A method of making an ultra-lightweight gypsum wallboard comprising:
mixing a modified beta-gypsum hemihydrate with pre-gelatinized starch, a stucco dispersant and water to form a stucco slurry, said modified beta-gypsum hemihydrate having been made by calcining gypsum, in the presence of a calcination modifier, under conditions for producing beta-gypsum hemihydrate and
allowing the stucco slurry to set between two substantially parallel cover sheets to form the ultra-lightweight gypsum wallboard.

9. The method of claim 6 wherein the calcination modifier is selected from the group consisting of saturated and unsaturated, monocarboxylic acids, dicarboxylic acids, tricarboxylic acids, polycarboxylic acids, and combinations thereof.

10. The method of claim 7 wherein the calcination modifier is selected from the group consisting of acetic acid, acetic anhydride, an acetic acid salt, adipic acid, adipic acid anhydride, an adipic acid salt, aspartic acid, aspartic anhydride, an aspartic acid salt, citric acid, citric acid anhydride, a citric acid salt, formic acid, formic acid anhydride, a formic acid salt, fumaric acid, a fumaric acid salt, gluconic acid, gluconic acid anhydride, a gluconic acid salt, maleic acid, maleic anhydride, a maleic acid salt, malic acid, malic anhydride, a malic acid salt, malonic acid, malonic acid anhydride, a malonic acid salt, oxalic acid, oxalic acid anhydride, a oxalic acid salt, succinic acid, succinic anhydride, a succinic acid salt, sulfosuccinic acid, sulfosuccinic anhydride, a sulfosuccinic acid salt, tartaric acid, tartaric anhydride, a tartaric acid salt, and combinations thereof.

11. The method of claim 6 wherein the calcination modifier is selected from the group consisting of maleic acid, tartaric acid, succinic acid, sodium succinate polyacrylic acid, lactic acid, aspartic acid, citric acid, sodium citrate, monosodium gluconate, tartaric acid tri-polyphosphate, monosodium gluconate, ethylene diamine tetra-acetic acid or its sodium salt, and the penta-sodium salt of amino trimethylene phosphonic acid.

12. The method of claim 6 wherein the pre-gelatinized starch is present in the stucco slurry an amount of 0.5 to 10% by weight of the modified beta-gypsum hemihydrate.

13. The method of claim 12 wherein the pre-gelatinized starch is selected from the group consisting of hydroxyethylated starch, pre-gelatinized corn starch, pre-gelatinized waxy corn starch, pre-gelatinized rice starch, pre-gelatinized wheat starch, hydroxypropylated starch, hydroxyethylated starch, succinated starch, acetylated starch, dextrinized starch, and combinations thereof.

14. The method of claim 6 wherein the calcination modifier is present in an amount of from about 0.05 to about 10 weight percent (wt. %) based on the weight of gypsum.

15. A method of making an ultra-lightweight gypsum wallboard comprising:
continuously calcining gypsum under conditions for producing beta-gypsum hemihydrate, said calcining being conducted in the presence of a calcination modifier, to thereby form a modified beta-gypsum hemihydrate;
mixing the modified beta-gypsum hemihydrate with pre-gelatinized starch, and a stucco dispersant thereby forming a stucco slurry, and
allowing the stucco slurry to set between two substantially parallel cover sheets to form the ultra-lightweight gypsum wallboard.

16. The method of claim 15 wherein the calcination modifier is selected from the group consisting of saturated and unsaturated, monocarboxylic acids, dicarboxylic acids, tricarboxylic acids, polycarboxylic acids, and combinations thereof.

17. The method of claim 16 wherein the calcination modifier is selected from the group consisting of acetic acid, acetic anhydride, an acetic acid salt, adipic acid, adipic acid anhydride, an adipic acid salt, aspartic acid, aspartic anhydride, an aspartic acid salt, citric acid, citric acid anhydride, a citric acid salt, formic acid, formic acid anhydride, a formic acid salt, fumaric acid, a fumaric acid salt, gluconic acid, gluconic acid anhydride, a gluconic acid salt, maleic acid, maleic anhydride, a maleic acid salt, malic acid, malic anhydride, a malic acid salt, malonic acid, malonic acid anhydride, a malonic acid salt, oxalic acid, oxalic acid anhydride, a oxalic acid salt, succinic acid, succinic anhydride, a succinic acid salt, sulfosuccinic acid, sulfosuccinic anhydride, a sulfosuccinic acid salt, tartaric acid, tartaric anhydride, a tartaric acid salt, and combinations thereof.

18. The method of claim 15 wherein the calcination modifier is selected from the group consisting of maleic acid, tartaric acid, succinic acid, sodium succinate polyacrylic acid, lactic acid, aspartic acid, citric acid, sodium citrate, monosodium gluconate, tartaric acid tri-polyphosphate, monosodium gluconate, ethylene diamine tetra-acetic acid or its sodium salt, and the penta-sodium salt of amino trimethylene phosphonic acid.

19. The method of claim 15 wherein the pre-gelatinized starch is present in the stucco slurry an amount of 0.5 to 10% by weight of the modified beta-gypsum hemihydrate.

20. The method of claim 19 wherein the pre-gelatinized starch is selected from the group consisting of hydroxyethylated starch, pre-gelatinized corn starch, pre-gelatinized waxy corn starch, pre-gelatinized rice starch, pre-gelatinized wheat starch, hydroxypropylated starch, hydroxyethylated starch, succinated starch, acetylated starch, dextrinized starch, and combinations thereof.

21. The method of claim 15 wherein the calcination modifier is present in an amount of from about 0.05 to about 10 weight percent (wt. %) based on the weight of gypsum.
